(19) United States
(12) Patent Application Publication
(10) Pub. No.: US 2019/0124041 A1
(43) Pub. Date: Apr. 25, 2019

(54) NETWORK-BASED MEDIA CONTENT CONTROL

(71) Applicant: Tata Communications (America) Inc., Herndon, VA (US)

(72) Inventors: Eric Alistair WILLIAMS, Pembroke Pines, FL (US); Kaustubh SAVE, Somerset, NJ (US)

(21) Appl. No.: 15/792,470

(22) Filed: Oct. 24, 2017

(51) Int. Cl. H04L 29/06

(52) U.S. Cl. CPC H04L 63/02; H04W 88/16; H04L 63/1416; H04L 63/0892

(57) ABSTRACT

A network-based media access control system positioned within a network that simultaneously monitors and regulates network media access from multiple, different access networks including a digital cellular access network and a Wi-Fi access network

### TECHNICAL FIELD

This disclosure relates generally to controlling access/distribution of media content to individuals. More particularly, it pertains to network-based media content controls that are applicable to multiple network access paths to that media.

### BACKGROUND

The networked and mobile computing environment that defines much of contemporary society has provided innumerable convenience and productivity benefits. Particularly noteworthy, networks interconnected via routable protocols—i.e., the Internet —have provided global platforms upon which profoundly useful data/information spaces such as the World-Wide-Web (WWW) are constructed.

As will be readily understood, not all data/information (content) available and accessible via the WWW (or other space(s)) is appropriate for all potential users or persons exposed to such content. Of concern, some accessible content is wildly inappropriate for children or others based on circumstances such as accessing/viewing while in public or during work/school. Compounding this problem is the fact that state of the art mobile devices—i.e., smartphones—provide access to this content via multiple access mediums including Wireless-Fidelity (Wi-Fi) and 4^{th} Generation, Long Term Evolution (LTE) cellular—among other mobile access technologies.

Consequently, systems, methods, and structures that provide media content control(s) where such media is accessed via multiple access mechanisms—would represent a welcome addition to the art.

### SUMMARY

An advance is made in the art according to aspects of the present disclosure directed to systems, methods, and structures for network-based media content control. In sharp contrast to the prior art, systems, methods, and structures according to the present disclosure provide media content access control when that media is accessed from devices having multiple access network capabilities/mechanisms. Advantageously, systems, methods, and structures according to the present disclosure provide such media access control without requiring any proxy servers and/or continuous re-establishment of IP leaseholds as mobile access devices move.

This SUMMARY is provided to briefly identify some aspect(s) of the present disclosure that are further described below in the DESCRIPTION. This SUMMARY is not intended to identify key or essential features of the present disclosure nor is it intended to limit the scope of any claims.

The term “aspect” is to be read as “at least one aspect”. The aspects described above and other aspects of the present disclosure are illustrated by way of example(s) and not limited in the accompanying drawing.

### BRIEF DESCRIPTION OF THE DRAWING

A more complete understanding of the present disclosure may be realized by reference to the accompanying drawing in which:

FIG. 1 shows a schematic diagram depicting an illustrative architecture of network based media content control according to aspects of the present disclosure;

FIG. 2 shows a flow diagram depicting an illustrative invocation/operation of a redirector in a subscriber device and subsequent operation of same according to aspects of the present disclosure;

FIG. 3 shows a swim-lane diagram depicting illustrative messages communicated among architectural elements of FIG. 1 during 3G/4G/LTE and/or other mobile access technologies according to aspects of the present disclosure;

FIG. 4 shows a swim-lane diagram depicting illustrative messages communicated among architectural elements of FIG. 1 during Wi-FI (or other) access according to aspects of the present disclosure;

FIG. 5 is a schematic block diagram of an illustrative programmable computer system suitable for executing instructions implementing methods according to the present disclosure

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope. More particularly, while numerous specific details are set forth, it is understood that embodiments of the disclosure may be practiced without these specific details and in other instances, well-known circuits, structures and techniques have not been shown in order not to obscure the understanding of this disclosure.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently-known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the disclosure.

In addition, it will be appreciated by those skilled in art that any flow charts, flow diagrams, state transition diagrams, pseudocode, and the like represent various processes which may be substantially represented in computer readable medium and so executed by a computer or processor, whether or not such computer or processor is explicitly shown.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Finally, and unless otherwise explicitly specified herein, the drawings are not drawn to scale.

By way of some additional background, we begin by noting that technological advances in mobile computing devices—i.e., tablets, smartphones—have made ubiquitous access to information spaces such as the World Wide Web an everyday occurrence. Part of these technological advances has involved the development of Wireless access to the Internet via access methods including Wi-Fi and 4G LTE which are simultaneously supported in many mobile devices. As will be readily appreciated and understood by those skilled in the art, due to the simultaneous support of multiple access methods (e.g., Wi-Fi/4G LTE) by these mobile devices, access to the entire Internet and WWW spaces by both methods is therefore advantageously made possible.

Such advantages are not without shortcomings, however. More particularly —and as previously noted—not all accessible/available content is appropriate for certain persons and/or circumstances. Accordingly, limiting access to—or blocking—inappropriate media content is oftentimes desirable and/or necessary.

We note at this point that access/content limiting systems, methods, and devices are well known in Wi-Fi and/or Local Area Network (LAN) environments. Such systems, methods, and devices oftentimes involve administration and/or configuration of LAN devices including access points (APs) or routers. Yet while such systems, methods, and devices are generally available in LAN environments including wired Ethernet and/or Wi-Fi, they do not extend to a digital cellular (i.e., 4G, LTE) environment and access. Accordingly, circumventing such access controls is simply employing an alternative access —i.e., LTE—which, as we have noted, are simultaneously supported/employed in contemporary mobile devices.

In response—and according to aspects of the present disclosure—we have developed systems, methods, devices, and architecture(s) for network based media content control that advantageously administratively limits access to certain Internet spaces/content for multiple access methods and technologies.

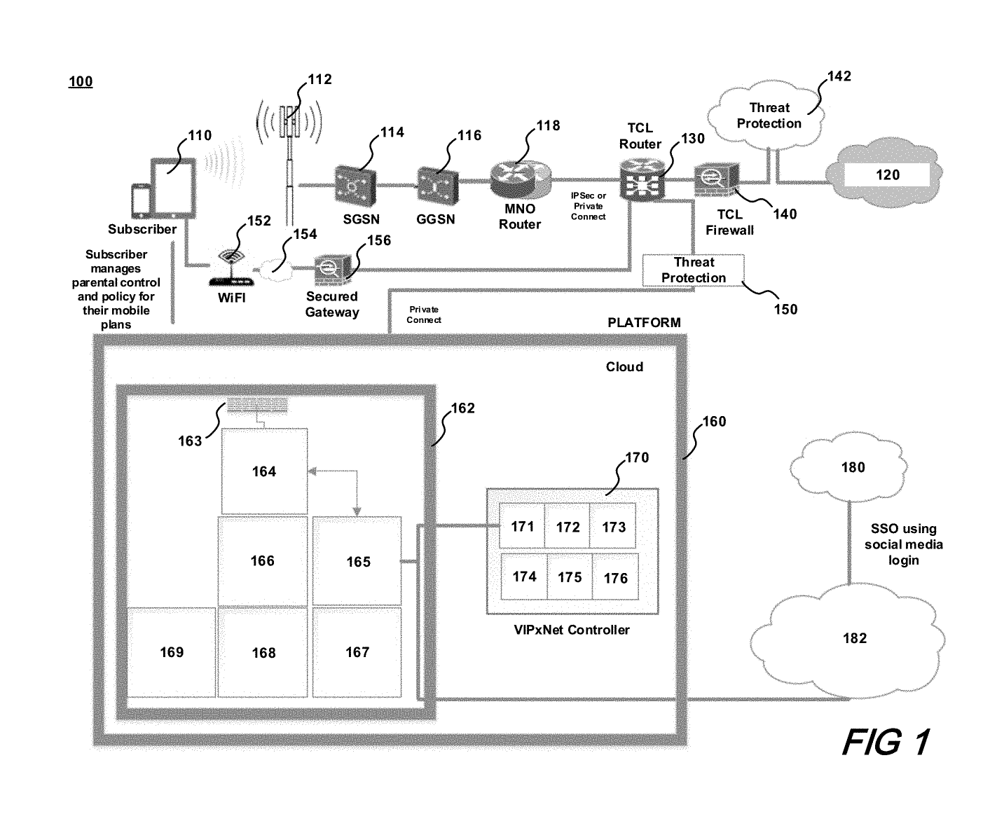

With reference now to FIG. 1, there is shown an illustrative architecture 100 according to aspects of the present disclosure that provides network-based access control to media content when that network including the media content is accessible from a device having multiple access technologies supported.

As illustratively shown in FIG. 1, a subscriber 110 is shown interacting with or otherwise in communication with an Internet 120. As we shall show and describe, that subscriber 110—which is shown illustratively as a portable or mobile device—accesses the Internet 120 via different technological systems and methods namely, Wi-Fi access network 102 and cellular system access network 101 and their associated methods.

We note at this time that while the subscriber 110 is depicted as a mobile (cell phone) and/or tablet device, those skilled in the art will readily appreciate that any device—whether mobile or desktop or other—that simultaneously supports multiple access methodologies—i.e., cellular and LAN-based (Wi-Fi, other wireless methods, or Wired LAN) is applicable to systems, methods and structures according to the present disclosure. For our purposes of discussion herein, we have illustratively depicted such a subscriber as a contemporary mobile, wireless device such as a cellular phone and/or tablet.

Of course, those skilled in the art will of course recognize and appreciate that such devices are commercially available from many commercial suppliers. Further, such devices will exhibit multiple unique identifier namely, an IMEI (International Mobile Equipment Indicator) or ESN (Electronic Serial Number)—for accessing the cellular access network (i.e., 4G LTE), a MAC (Media Access Control) address for accessing the LAN access network (i.e., Wi-Fi, Ethernet, etc). Note further that while we have used such unique identifiers illustratively, alternative individual technologies/protocols are contemplated as within the scope of this disclosure.

With continued reference to FIG. 1, it may be observed that as illustratively shown therein LAN access network 102 interposed between subscriber 110 and Internet 120 includes a Wi-Fi radio device 152 connected to a secured gateway 156. Shown interposed between the radio device 152 and the secured gateway 156 is further, optional access network 154 that may include further subscriber devices and/or nodes and/or network elements that are known to exist in such network environments. Note further that while we have used the term “LAN” to describe the specific type of access network as an alternative to the cellular access network 101, those skilled in the art will recognize that no particular geographic scope of such access network is required. That is to say—an alternative access network may encompass local area networks (LAN), metropolitan area networks (MAN), or wide area networks (WAN). Still further, such access network may encompass combinations of such networks and technologies and employ private and/or public facilities.

Those skilled in the art will appreciate that as shown in FIG. 1, Wi-Fi radio device 152 may comprise an access point or router or other known device that functions as providing radio (i.e., Wi-Fi) access to the access network 102. As will be further understood, such devices may be configured to provide local Internet addresses and/or other related configuration information such as a subnet mask and default gateway identifier(s) (i.e., using/providing Dynamic Host Configuration Protocol (DHCP)).

Gateway 156—shown as secured gateway—interconnects the network 154 to router 130. As is known by those skilled in the art, a gateway is a network node that interfaces one network to another wherein the two networks employ different protocols. Such gateways may provide protocol translators, rate converter and/or signal translators as necessary to provide such interoperability between networks. As depicted in FIG. 1, the gateway 156 interconnects the network 154 to router 130 which is shown via secure Internet Protocol (IP Sec) or alternative private connections as known in the art.

As shown further in FIG. 1, cellular access network 101 also connects subscriber 110 to Internet 120. We note at this point that with respect to the cellular access network 101 (or mobile network) we generally refer to a communication network where the last link is wireless. Typically, this wireless portion of the network is distributed over land areas as “cells”, each served by at least one fixed-location transceiver 112 (or base station including antenna(s)) These base stations provide the cell with the network coverage that may be used for the transmission of voice, data and others.

As will be readily understood and appreciated, telecommunications providers have deployed voice and data cellular networks over most of the inhabited land areas of the Earth. This allows mobile phones and mobile computing devices (such as the subscriber 110) to be connected to the public switched telephone network (not specifically shown) and the public Internet 120. While most cellular networks are public—in that they support a number of public subscribers—private cellular networks are known and likewise are consistent with the teachings of the present disclosure also.

As depicted illustratively, subscriber 110 (via mobile device) interacts with cellular network transceiver 112 which in turn provides access to Internet 120. As depicted in FIG. 1, interposed between the cellular transceiver 112 and the Internet 120 are Serving GPRS Support Node (SGSN) or Serving Gateway (SGW) 114, Gateway GPRS Support Node (GGSN) or Packet Data Network Gateway (PGW) 116, Mobile Network Operator Router (MNO) 118, router 130, and Firewall 140.

We note that a General Packet Radio Service (GPRS) is associated with a GPRS core network that serves as a central part of the overall cellular system and allows 2G, 3G, 4G and other mobile networks to transmit Internet Protocol (IP) packets to external networks such as the Internet. Operationally, the SGSN or SGW 114 is a component of that GPRS network and handles packet switched data within the network—for example, the mobile management and authentication of users. It generally performs functions similar to that performed by a Mobile Switching Center (MSC) for voice traffic.

Connected to the SGSN or SGW 114 is GGSN or PGW 116 that provides interworking between the GPRS network and an external packet switched network such as the Internet 120. From the point of view of the external network (cellular access network), the GGSN or PGW acts as a “router” to a subnetwork as it hides the GPRS infrastructure from the external network. When a GGSN or PGW receives data addressed to a specific user (subscriber), it checks if the user is active. If it is, the GGSN or PGW forwards the data to the SGSN or SGW service the mobile user (in this illustrative FIG. 1, SGSN or SGW 114). If however, the mobile user is inactive, the data are discarded. Conversely, mobile-originated packets (from subscriber 110, for example) are routed to the correct network by the GGSN or PGW.

To perform these functions, the GGSN or PGW generally maintains a record of active mobile users and the SGSN or SGW the mobile users are attached to. It allocates IP addresses to mobile users and—in a public environment—is responsible for billing.

Further with respect to FIG. 1, GGSN or PGW 116 is connected to MNO Router (118) which routes packets received from GGSN or PGW 116 to Internet 120—or elsewhere. In this specific illustrative example depicted in FIG. 1, the MNO Router 118 is connected to Media Access Control Router (130)—which as we shall describe—facilitates much of the functionality according to the present disclosure with respect to simultaneously controlling (Internet) media access to a subscriber 110 where that subscriber may simultaneously access that media via multiple simultaneous access networks—e.g., 4G LTE and Wi-Fi/Wired.

As is known and will be readily appreciated, routers (i.e., router 118, router 130) are a type of telecommunications equipment that are used to connect multiple networks together. As such, a router forwards (routes) data packets between networks. Routers analyze data being sent over a network, optionally change how it is packaged, and send it to another network or to a different type of network. Note that routers oftentimes exhibit/provide many different including: firewall, virtual private network (VPN); IP telephony. As we shall discuss in greater detail, Router 130 receives all Internet directed traffic from subscriber device(s) 110 through the effect of application/redirector executing on subscriber device(s) 110, and then verifies access of both the subscriber device and content accessed via system platform 160.

Shown further in FIG. 1, threat protection operations 142, 150 for Internet 120 and platform communication are a t of processes/operations that examine content (from Internet and/or Intranet) and determine whether any malicious code and/or virus is present in that content. As will be readily appreciated by those skilled in the art, a virus is a relatively small program or section of code that is designed (usually) with malicious intent. A virus attaches itself to other programs or files and are capable of copying themselves throughout a computer or network. Threat protection 142, 150 operations examine any content destined for subscriber devices 110 to determine whether such malicious code exists in the downloaded content and prevents its download. Advantageously, threat protection operations 142, 150 will protect against any of a number of viruses including file infector viruses, boot sector viruses, macro viruses, worms, and trojan horses—among others. Threat protection 142, 150 operations provide real-time scan capability—monitoring and checking downloaded items destined for subscriber devices on an ongoing basis as they are downloaded. Additionally, threat protection operations may be updated both conveniently and regularly, insuring that all subscribers are protected from most current code threats.

As shown further in FIG. 1, system platform 160 includes controller 170 and Manager 162. Generally, system platform 160 verifies/authenticates subscriber(s)/subscriber devices 110 and provides media access. To facilitate the verification/authentication services offered by system platform 160, the platform is networked to social media and other publicly available web sites such as Facebook, Google, and LinkedIN 180 which may advantageously allow utilization of single-sign-on techniques 181 using these social media sites in conjunction with OAuth 2.0 or other sign-on methods technologies 182, which advantageously enable third-party application(s) to obtain limited access to an HTTP service—either on behalf of a resource owner by orchestrating an approval interaction between a resource owner and the HTTP service—or by allowing the third-party application to obtain access on its own behalf.

Controller 170 illustratively incudes Radius server 171, DHCP controller 172, DNS controller 173, LDAP controller 174, Syslog Server 175, and Account DataBase 176. ess control(s) to media accessed by such subscriber devices according to aspects of the present disclosure. Manager 160 includes WebServer 164, Identity Manager 165, AppServer 166, a set of databases namely, Usage Information 169, PolicyDB 168, and User Respository 167—all of which may reside behind firewall 163 which may advantageously exhibit a public Internet Protocol address allowing Manager 162 access from public Internet.

With continued reference to FIG. 1, we note that firewall 163 is configured to prevent unauthorized access to the platform 160 from public IP networks such as the Internet 120. As will be readily appreciated, such a firewall may be either hardware/software or a combination. Messages entering or leaving the platform pass through the firewall, which examines messages and blocks those that do not meet specified security criteria. Accordingly, firewall 163 greatly facilitates remote access to platform 160 from outside while providing secure access only to authorized processes/persons.

Continuing with our discussion of platform 160 and in particular manager 162, WebServer/Security Proxy 164. As is known in the art, a web server 164 processes requests via HTTP while a security proxy may direct any client requests to an appropriate backend. This configuration advantageously provides an additional level of abstraction and control of network traffic between clients and servers.

App Server TomEE+ 166 is a Java Enterprise Edition of Apache Tomcat that combines several Java enterprise projects including Apache Open EJB, Apache OpwnWebBeans, Apache OpenJPA, Apache MyFaces. Apache Tomcat serveris a Java Servlet container that implements several Java EE specifications including Javla Servlet, Java Server Pages, Java EL and Websocket and provides a Java HTTP web server environment in which Java code can run.

As will be readily appreciated by those skilled in the art, the configuration(s) shown and described herein are only one illustrative example,—other types of configuration with similar technologies can be used to accomplish the same implementation goals.

Identity Manager (OpenAM) 165, provides access management and supports a number of features including authentication, authorization, risk authentication, federation and single sign-on.

User repository 167 is a directory server based on OpenDJ that implements Lightweight Directory Access Protocol (LDAP)—which is an application protocol for accessing and maintaining distributed directory information services over an Internet Protocol (IP) network.

Databases used for usage information 169 and policies 168 are advantageously configured using open source database programs such as MongoDB, Cassandra (NoSQL) for usage information 169 or object-relational database management systems (Postgres) for Policy DB 168. Note that while specific systems are described herein for these functions, those skilled in the art will appreciate that other alternatives are known and contemplated within the scope of this disclosure.

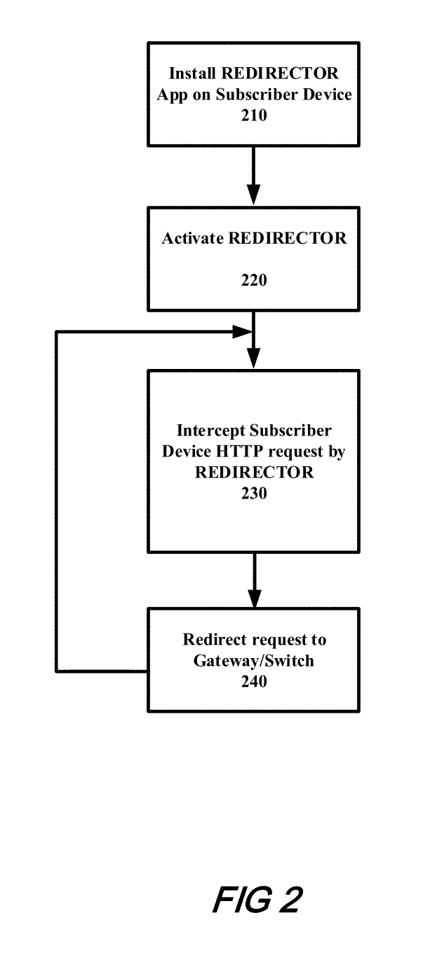

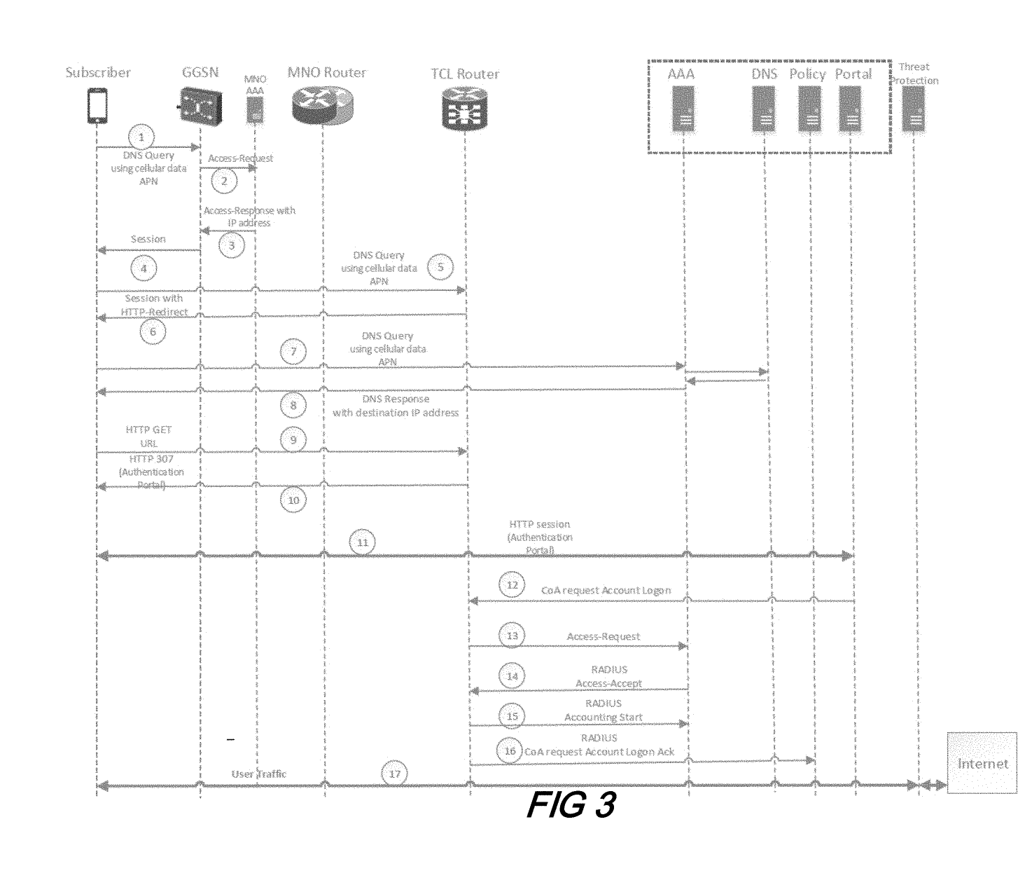

Shown further in FIG. 1 is controller 170. As noted previously, controller 170 includes Radius Server 171 which is a network protocol that provides centralized authentication, authorization, and accounting (AAA) management for users. The particular protocol exchanges including Radius Server 171 will be described in greater detail with respect to FIG. 2 and FIG. 3.

DHCP controller 172 is a known set of client/server protocols that automatically provides an IP host with its IP address and other related configuration information such as subnet mask and default gateway. DHCP allows hosts to obtain required TCP/IP configuration information from a DHCP server.

DNS server 173 is one of the standard suite of protocols that comprise TCP/IP and together a DNS client and DNS server provide computer name-to-IP address mapping name resolution services to computers and users.

LDAP server 174 (Lightweight Directory Access Protocol) is a directory service the provides a mechanism used to connect to, search, and modify Internet directories.

Syslog server 175 provides a mechanism for sending log messages within the network.

With these architectural elements described, we may now describe the operational processes/procedures with respect to the architecture and elements. With specific reference to the subscriber device—shown as mobile phone and/or tablet in the drawing—we note that such device(s) is/are well known in the art and may include mobile telephone(s), tablets, or other portable computing devices that support/provide Internet access via multiple access networks including 4G-LTE and Wi-Fi/others.

Known further is the fact that such mobile devices employ a mobile operating system (mobile OS) which coordinates communication among the mobile device operational components, i.e., central processing unit, Memory, Input/Output components including user interface and mobile communications elements. Illustrative examples of such mobile OS include iOS and Android—among others.

One additional aspect of such mobile OS is the support of applications (APPs) that generally provide additional user functionality such as web browser, email client, calendar, mapping, and a plethora of others. According to an aspect of the present disclosure—an APP is employed in a mobile device to provide “redirector” functionality.

Operationally, a redirector according to the present disclosure will identify/intercept Internet HTTP and/or HTTPS messages and redirect them to TCL Router/Gateway/Switch as shown illustratively in the figure described previously. The Gateway/Switch then queries platform to determine whether the device/user/site is permitted access. If the device/user/site is permitted, then normal message flow(s)—via the Gateway/Switch follow. If device/user/site is not permitted—the message flow(s) are blocked.

As noted previously—and in marked contrast to any prior art methods, structures, and systems/architectures—media access control according to the present disclosure will operate when user devices simultaneously support multiple access networks and technologies. Accordingly, media access control according to the present disclosure is effective regardless of access network employed by a device at any particular instant.

With reference to FIG. 2, there is shown a flow diagram illustrating generalized invocation and operation of redirector APP on subscriber device according to aspects of the present disclosure. As shown in that figure, redirector is first installed (Block 210) and activated (Block 220). Subsequent to this activation, redirector will intercept subscriber device HTTP (or HTTPS) operations (Block 230) and redirect those requests to Gateway/Switch (Block 240). While not specifically shown in this flow diagram, Gateway/Switch will proceed with an authorization/authentication process initially and then subsequently require messages to/from the subscriber device be evaluated by threat protection operation previously described.

Turning now to FIG. 3, there is shown an illustrative “swim lane” diagram outlining message flow(s) between subscriber device and architectural elements according to aspects of the present disclosure. As noted previously, the present disclosure advantageously—and in sharp contrast to the prior art—operates to control media content in environments where a subscriber device may access that media over multiple access networks including 4G LTE and Wi-FI—and others. The illustrative diagram shown in this figure is for 4G LTE access.

As illustratively shown in FIG. 3, at STEP 1, subscriber device (shown as cellular phone in figure) will generate/transmit a DNS query using cellular data Access Point Name (APN). As will be known by those skilled in the art, an APN is a name for the settings the mobile device reads to set up a connection to a gateway between a carrier's cellular network and the public Network. At STEP 2, the query is redirected to a MNO MNO Authentication, Authorization, and Accounting (AAA) system, the procedures of are employed and respond to the subscriber device with an IP address at STEP 3, which begins a session at STEP 4.

Those skilled in the art will of course understand that a session—as that term is used herein—describes a semi-permanent interactive information interchange—also known as a dialogue, conversation, or meeting—between two or more communicating devices (in this scenario). An established session is a basic requirement to perform a connection-oriented communication and a basic step to transmit in connectionless communication modes.

Once the session is established, the DNS query using cellular data APN is forwarded to Gateway/Switch at Step 5, which in turn responds with a session with HTTP-redirect message at Step 6. Subsequently—at Step 7—the DNS query with cellular data APN is directed to system platform—where platform AAA processes Authenticate, Authorize, and provide any Accounting for user/subscriber of mobile device. If authentication/authorization is successful and user/subscriber/device is permitted access, DNS response with destination IP address is returned to subscriber device at Step 8.

In response, at Step 9, subscriber device transmits an HTTP GET URL message to Router/Switch which generates/returns HTTP 307 (Authentication Portal) message in response at Step 10.

At this point—at Step 11—the subscriber device and platform have established an HTTP session between the pair. Further AAA activities now proceed between Gateway/Switch as a Change of Authorization (CoA) request for account logon is sent from system platform to Gateway/Switch at Step 12. Subsequently, Access-Request (Step 13), Radius Access-Accept (Step 14), Radius Accounting Start (Step 15) and Radius CoA request Account LogonAck (Step 16) messages are exchanged between Gateway/Switch and system platform.

Since this subscriber device is now authenticated/authorized/accounted-for, general user traffic may proceed from subscriber device and the Internet while experiencing benefits of threat protection.

As noted previously, even if subscriber device is relocated—say a mobile device—the overall process will continue to operate without additional re-initialization as the message flow was initially managed by Gateway/Switch. There is no need to re-initialize any session due to movement of the subscriber device.

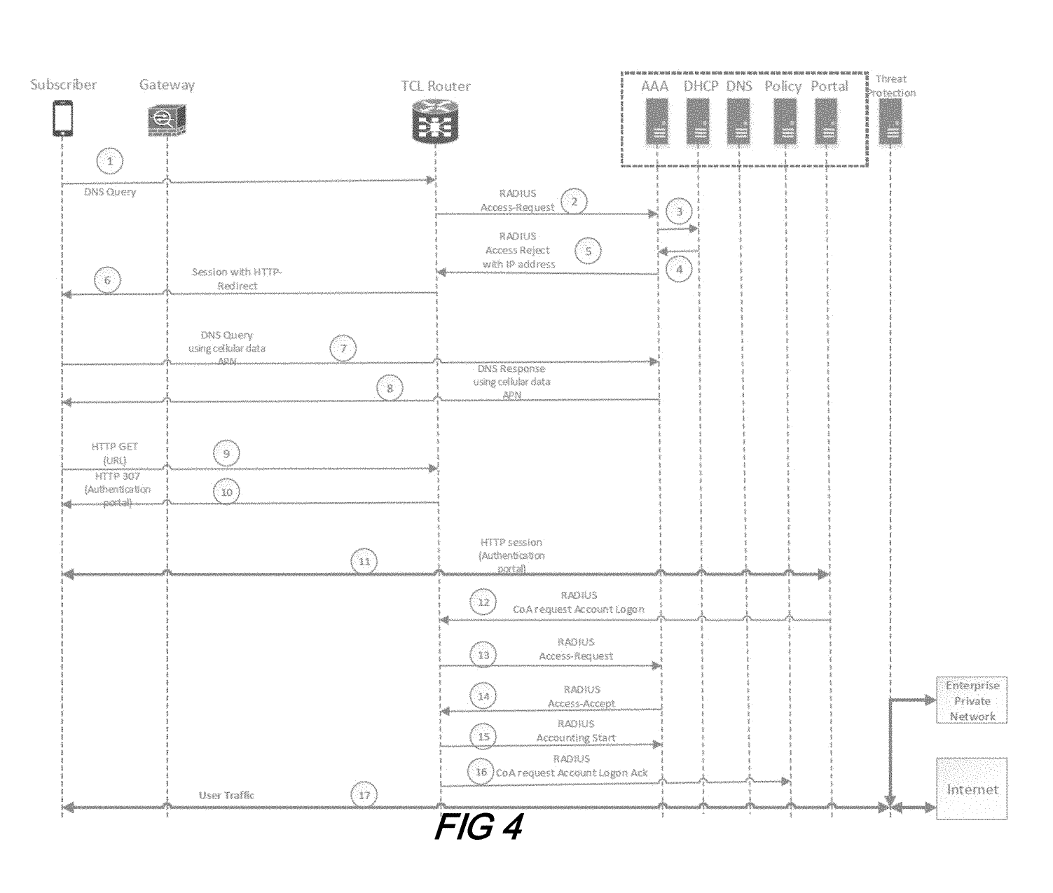

With reference now to FIG. 4, there is shown a swim-lane diagram illustrating message flows between subscriber device and network elements when the subscriber device is attempting Internet (or Private Network) access via a Wi-Fi (or other LAN) access network through a Gateway device—according to aspects of the present disclosure.

As shown in the figure, a DNS query is initiated by subscriber device at Step 1 and is forwarded via network Gateway to Gateway/Switch. In response, Gateway/Switch at Step 2 generates Radius Access-Request which is sent to system platform for AAA processes and subsequent DHCP request (Step 3) which—if successful —will result (Step 4) with an IP address being sent to AAA and platform provides Radius Access Reject message with IP address (Step 5) to Gateway/Router. Session HTTP redirect is initiated with subscriber device at Step 6, and DNS query with cellular data APN is then formed/transmitted at Step 7 to system platform. DNS response using cellular data APN is returned to subscriber device at Step 8.

In response, at Step 9, subscriber device transmits an HTTP GET URL message to Router/Switch which generates/returns HTTP 307 (Authentication Portal) message in response at Step 10.

At this point—at Step 11—the subscriber device and platform have established an HTTP session between the pair. Further AAA activities now proceed between Gateway/Switch as a Change of Authorization (CoA) request for account logon is sent from system platform to Gateway/Switch at Step 12. Subsequently, Access-Request (Step 13), Radius Access-Accept (Step 14), Radius Accounting Start (Step 15) and Radius CoA request Account LogonAck (Step 16) messages are exchanged between Gateway/Switch and system platform.

This subscriber device is now authenticated/authorized/accounted-for, general user traffic may proceed from subscriber device and the Internet (or Enterprise Private Network) while experiencing benefits of threat protection.

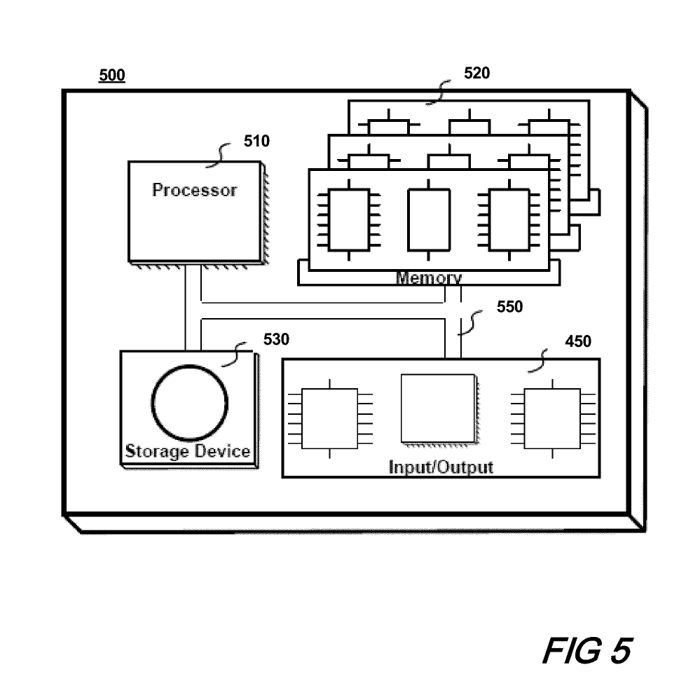

Finally, FIG. 5 shows an illustrative computer system 500 suitable for implementing methods and incorporation into systems according to an aspect of the present disclosure. As may be immediately appreciated, such a computer system may be integrated into another system may be implemented via discrete elements or one or more integrated components. The computer system may comprise, for example a computer running any of a number of operating systems. The above-described methods of the present disclosure may be implemented on the computer system 500 as stored program control instructions.

Computer system 500 includes processor 510, memory 520, storage device 530, and input/output structure 540. One or more busses 550 typically interconnect the components, 510, 520, 530, and 540. Processor 510 may be a single or multi core.

Processor 510 executes instructions in which embodiments of the present disclosure may comprise steps described previously and/or outlined in one or more of the Drawing figures. Such instructions may be stored in memory 520 or storage device 530. Data and/or information may be received and output using one or more input/output devices.

Memory 520 may store data and may be a computer-readable medium, such as volatile or non-volatile memory. Storage device 530 may provide storage for system 500 including for example, the previously described methods. In various aspects, storage device 530 may be a flash memory device, a disk drive, an optical disk device, or a tape device employing magnetic, optical, or other recording technologies.

At this point, those skilled in the art will readily appreciate that while the methods, techniques and structures according to the present disclosure have been described with respect to particular implementations and/or embodiments, those skilled in the art will recognize that the disclosure is not so limited. Accordingly, the scope of the disclosure should only be limited by the claims appended hereto.

1. A network-based media access control system comprising:
the network, simultaneously accessible via a digital cellular access network (4G LTE) and a Wi-Fi (802.11) access network; and
a media access control platform, situated within the network, said media access control platform configured to control media access from both access networks.

2. The media access control system according to claim 1 further comprising a Gateway/Switch interconnected to both access networks and the network, the Gateway/Switch configured to forward network access requests received from an access network to the media access control platform.

3. The media access control system according to claim 2 wherein the Gateway/Switch is further configured to forward media access control platform responses to a subscriber device via an access network.

4. The media access control system according to claim 3 wherein the media access control platform further includes an Authentication, Authorization, and Accounting (AAA) module for determining access to media by a subscriber.

5. The media access control system according to claim 4, wherein the media access control platform further includes a threat protection module configured to monitor media communicated between an external network and a subscriber device to determine whether the media includes code harmful to the operation of the subscriber device.
